(19) United States
(12) Patent Application Publication
(10) Pub. No.: US 2013/0013516 A1
(43) Pub. Date: Jan. 10, 2013

(54) SOCIAL NETWORK FINANCIAL PORTAL

(76) Inventor: Andrew R. Hamilton, Dundee (GB)

(21) Appl. No.: 13/178,541

(22) Filed: Jul. 8, 2011

(51) Int. Cl. G06Q 40/00; H04L 9/32

(52) U.S. Cl. 705/75; 705/42

(57) ABSTRACT

A financial portal is provided which allows the transfer of funds between “friends” within a social network application.

### FIELD OF THE INVENTION

This invention relates to a social network financial portal. More particularly, but not exclusively, the invention relates to a social network financial portal graphical user interface.

### BACKGROUND TO THE INVENTION

The ubiquitous nature of Internet-based social networks, such as Facebook (trademark), Bebo (trademark), MySpace (trademark), Twitter (trademark) or the like, has lead to a revolution in the way that people interact. The vast majority of interactions across these social networks are based upon trusted relationships between friends, associates and third parties, such as companies. The interactions effected across these social networks usually involve the exchanges of information between parties who have established a connection between themselves or the posting of HTML links to web-pages or multi-media online content. However, there is currently no mechanism by which these social networks can be employed to effect financial transactions using these trusted relationships, any financial transaction, for example a transfer of funds between friends, can only be carried out by leaving the social network and carrying out the financial transaction via a third party web-site, for example PayPal™. The current system involves the user in the selection of accounts etc., and is inherently complex for users to execute.

### SUMMARY OF THE INVENTION

According to a first aspect there is provided a financial portal application operable to interact with a computer-based social network application, the financial portal application comprising:

a graphical user interface component operable to display: a list of members of the social network associated with a user; and at least one financial transaction option selectable by the user for transferring funds to a member of the social network, without the user having to leave the social network to execute the transaction; and

a transaction request component for transmitting a transaction request to a transaction application that stores account information relating to the list of members.

The transaction request component may be operable to prompt the user to enter security credentials prior to transmitting the transaction request. The security credentials may comprise a username and passcode.

The transaction application may validate the user's security credentials prior to creating a transaction to be authorized by a remote authorization server.

The transaction application may be executing on a transaction server, separate from the authorization server and separate from a server executing the social network application.

The remote authorization server may validate the transaction or may route the transaction to another authorization server to be validated (for example, if the user's account is not held by the first authorization server, then that authorization server may route the transaction to an authorization server that does hold the user's account). Alternatively, a transaction switch may be used located between the transaction server and a plurality of authorization servers (one associated with each financial institution that a member has an account with), and operable to route the transaction to the correct authorization server.

The list of members of the social network associated with a user may be depicted on the GUI as icons, with an icon for each member.

The transaction request may transmit a transaction message comprising: details of the requested transaction (for example, amount of money to be transferred and the type of transaction), the user's security credentials, and an identification of the recipient (from the list of members) based on the social network identifier associated with that member who is to receive the money (the “recipient member”). The transaction request is preferably transmitted over a secure link. The user's security credentials may be encrypted.

The transaction application may use the transaction message to create a funds transfer message for forwarding to the authorization server.

The funds transfer message preferably includes details of the payor and payee accounts involved, details of the financial institutions that hold those accounts, details of the transaction type, and details of the transaction amount.

If the recipient member has not registered an account with the transaction application, then the transaction application may be operable to send a message to the recipient member to request him/her to register an account. This message may be sent by electronic mail, SMS, MMS, as a social network news feed item, or in any other convenient manner.

The financial portal application may further comprise an image processing component operable to receive an image of a document (such as an invoice or a cheque) and to decode that image to ascertain account information to which payment should be sent.

The transaction application may be operable to send a transaction confirmation message to both the user and the recipient member on successful completion of the transaction. This message may be sent by electronic mail, SMS, MMS, as a social network news feed item, or in any other convenient manner.

The social network application may execute on a web server. The financial portal application may be separate from the social network application but connected thereto via an application programming interface (API). For example, the financial portal application may be downloaded to the user's computer as a plug-in that can be accessed by the user's web browser. Alternatively, the financial portal application may be integrated into the social network application so that no local plug-in is required.

In embodiments where the social network application and the financial portal application are not integrated, the user's web browser may communicate with the transaction application executing on a remote transaction server that communicates with a remote authorization server.

Alternatively, in embodiments where the social network application and the financial portal application are integrated, the transaction application may execute on the same server (a “consolidated server”) as the social network application and the financial portal application. In such embodiments, the consolidated server may communicate with the authorization server.

As used herein, currency, funds, monies, and the like all refer to money that can be used by a recipient as legal tender to purchase goods and services and to pay debts. In other words, it does not refer merely to electronic currency that is only accepted at certain web sites.

As used herein, “within the social network”, “without having to leave the social network”, and the like phrases mean that the user is not redirected to a different web page to execute the financial transaction. In other words, the social network itself (as enhanced by the financial portal application) allows the user to execute the financial transaction. In contrast, if a user is redirected to a payment web site, then this is not within the social network.

It should now be appreciated that this aspect has the advantage of providing a financial portal on a social network to allow members of the social network to transfer funds to each other without having visibility to any account details of the other members of the social network and without having to leave the social network infrastructure.

According to a second aspect of the present invention there is provided software which when executed on a processor causes a social network application to provide a user interface within the social network arranged to receive user instructions relating to a financial transaction, the software being further arranged to instigate said financial transaction.

The software may be arranged to cause the processor to provide a graphical user interface (GUI). The GUI may comprise at least one icon indicative of money and arranged to be actuated by the user as part of said user instructions. The GUI may comprise at least one icon indicative of a second party to the transaction and arranged to be actuated by the user to indicate that said party is a second party to the transaction.

The software may be further arranged to cause the processor to request credentials from the user prior to instigating the financial transaction. The software may be further arranged to cause the processor to access an account of a second party to the financial transaction within the social network to determine a preferred account to enable completion of the financial transaction. The software may be further arranged to cause the processor to generate and forward a message to the second party if no account details are available.

The software may be further arranged to allow a party (an account owner) to create an account reference that can be accessed by other parties, where the account reference does not disclose the account owner's account details, but provides the social network software with the account details to enable funds crediting to the account owned by the account owner. The account reference may take the form of an icon that can be displayed on a social network Web page. The account reference may be combined with an icon illustrating the social network member. The account reference is preferably linked to an account store including account details sufficient to identify uniquely the account owner's account. The account details may include a plurality of accounts (such as savings account, checking account, business account, and the like), with one account set as the default account.

This account reference has the advantage that all account details of the recipient of funds are hidden from the person or entity transferring funds to the account owner.

The account store is preferably configured to be updated by the account owner, provided sufficient identity credentials (such as username, passcode, and the like) are provided. Preferably, only the account owner has visibility to the details for that account retained by the account store.

The software may be operable to send a message to a user, where the message indicates that someone desires to transfer funds to the user and the user must create an account reference to receive those funds.

The software may be further arranged to cause the processor to confirm that the user has sufficient funds in their account to complete the financial transaction by communicating with a financial institution hosting the user's account.

The software may be further arranged to cause the processor to instruct a camera to capture an image of at least a portion of a piece of media bearing an optical code thereupon, and being further arranged to cause the processor to extract information relating to an account of at least one party to the financial transaction from the optical code. This is advantageous when a user desires to pay a bill (or invoice) that includes an optical code incorporating account details of the vendor that issued the bill (or invoice).

The software may be arranged to link to the social network application via a proprietary social network API. Alternatively, the software may be part of the social network application (for example, located on a web server that also provides the social network web site).

According to a third aspect of the present invention there is provided a social network user interface comprising an icon representing a party to a financial transaction and a user instruction receiving portion arranged to receive user instructions relating to said financial transaction, the user interface being arranged such that an interaction between the icon and the instruction receiving portion instigates said financial transaction.

The user interface may comprise a graphical user interface (GUI). The GUI may comprise at least one icon indicative of a sum of money and arranged to be actuated by the user as part of said user instructions. The GUI may comprise at least one icon indicative of a second party to the transaction and arranged to be actuated by the user to indicate that said party is a second party to the transaction. The GUI may further comprise a plurality of additional icons for additional functions, such as to create an account reference, to indicate a source of funds for transfer, to indicate a vendor to whom funds are to be transferred, and the like.

According to a fourth aspect of the present invention there is provided a processor arranged to execute software according to the first or second aspects of the present invention.

According to a fifth aspect of the present invention there is provided a financial institution host computer connected via a network connection to a processor according to the fourth aspect of the present invention and further arranged to execute at least a portion of said financial transaction.

According to a sixth aspect of the present invention there is provided a social network transaction system comprising: a graphical user interface component operable to display to a user: a list of members of the social network associated with the user; and at least one financial transaction option selectable by the user for transferring funds to a member of the social network, without the user having to leave the social network to execute the transaction; a transaction request component for transmitting a transaction request to a transaction application; a transaction application operable to store account information relating to the list of members and to create a funds transfer message using the transaction request; and an authorization server operable to execute the financial transaction in response to the funds transfer message.

The social network transaction system may further comprise a social network application for providing social network information to the user via the graphical user interface component.

According to a seventh aspect of the present invention there is provided a method of executing a financial transaction within a social network, the method comprising the steps of:

presenting to a user icons representing a plurality of members of the social network associated with the user;

presenting to the user at least one financial transaction option selectable by the user for transferring funds to one of the members of the social network;

receiving a request from the user to transfer funds from the user to an identified member from the plurality of members;

receiving information from the user identifying an amount of money to be transferred to the identified member; and

transmitting a transaction request to a transaction application so that the user can transfer funds to the identified member without the user having to leave the social network to execute the transaction.

The method may comprise the further step of receiving security credentials from the user prior to transmitting a transaction request.

According to an eighth aspect of the present invention there is provided a method of carrying out a financial transaction within a social network comprising the steps of:

selecting a party to the transaction on a user interface of the social network application;

selecting an amount of monies involved in the transaction at a user instruction receiving portion of the user interface; and

instigating the transaction by causing the selected party and user instruction receiving portion to interact within the user interface.

The step of selecting an amount of monies may comprise selecting an amount of monies from a single source, or from a plurality of different sources (such as different accounts).

The method may comprise requesting credentials from the user prior to instigating the financial transaction.

The method may comprise accessing an account of a second party to the financial transaction within the social network to determine an account to enable completion of the financial transaction. The method may comprise instructing a camera to capture an image of at least a portion of a piece of media bearing an optical code thereupon, and being further arranged to cause the processor to extract information relating to an account of at least one party to the financial transaction from the optical code. The method may comprise generating and forwarding a message to the second party if no preferred account is found. The method may comprise confirming that the user has sufficient funds in their account to complete the financial transaction.

According to a ninth aspect of the present invention there is provided software which when executed on a processor causes a social network application to provide a user interface within the social network arranged to (i) allow a first member of the social network to select a transaction amount, (ii) allow the first member of the social network to select a second member of the social network as the recipient of the transaction amount, and (iii) transfer the transaction amount from an account associated with the first member to an account associated with the second member based on account information provided to the social network by the first and second members prior to the transaction and stored by a transaction application for future transactions.

### BRIEF DESCRIPTION OF THE DRAWINGS

These and other aspects will be apparent from the following detailed description, given by way of example, with reference to the accompanying drawings, in which:

FIG. 1 is a schematic diagram of a social network transaction system for implementing a social network financial portal according to a first embodiment of the present invention;

FIGS. 2A and 2B illustrate a graphical user interface (GUI) provided by software executing on a computer in the system of FIG. 1 and operated by a user of the social network;

FIG. 3 is a simplified flowchart illustrating steps implemented by the computer executing the GUI of FIGS. 2A and 2B in receiving a request from the user to transfer funds between members of a social network;

FIG. 4 is a simplified flowchart illustrating steps implemented by a transaction application in response to a request to transfer funds between members of a social network received from the computer executing the GUI of FIGS. 2A and 2B; and

FIG. 5 is a schematic diagram of a social network transaction system for implementing a social network financial portal according to a second embodiment of the present invention.

### DETAILED DESCRIPTION

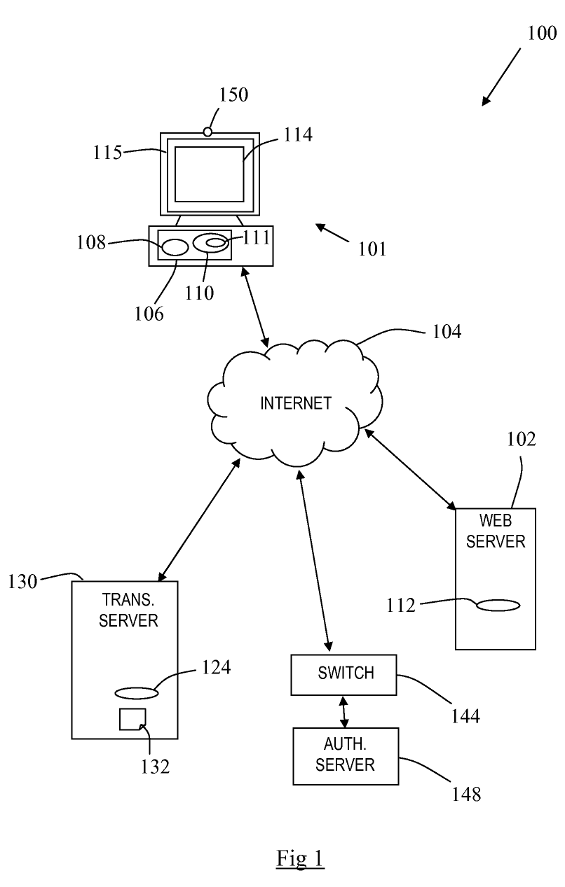

Referring now to FIG. 1, a social network transaction system 100, according to one embodiment of the present invention, is shown.

The transaction system 100 comprises a networked computer 101 connected to a remote server 102 (in the form of a web server) via the network 104 (in the form of the Internet). A processor 106 in the computer 101 runs a web-browser application 108. The web-browser application 108 includes a plug-in component 110 (including a transaction request component 111) that uses an application programming interface (API) associated with a social network application 112 executing on the web server 102. The combination of the web-browser application 108 and the plug-in component 110 causes a graphical user interface (GUI) 114 for the social network application 112 to be rendered on a display 115 of the computer 101. In particular, when the web-browser application 108 loads a web page associated with the social network application 112, the plug-in component 110 provides additional features on the social network GUI 114, which can be used by a social network member (the “user”).

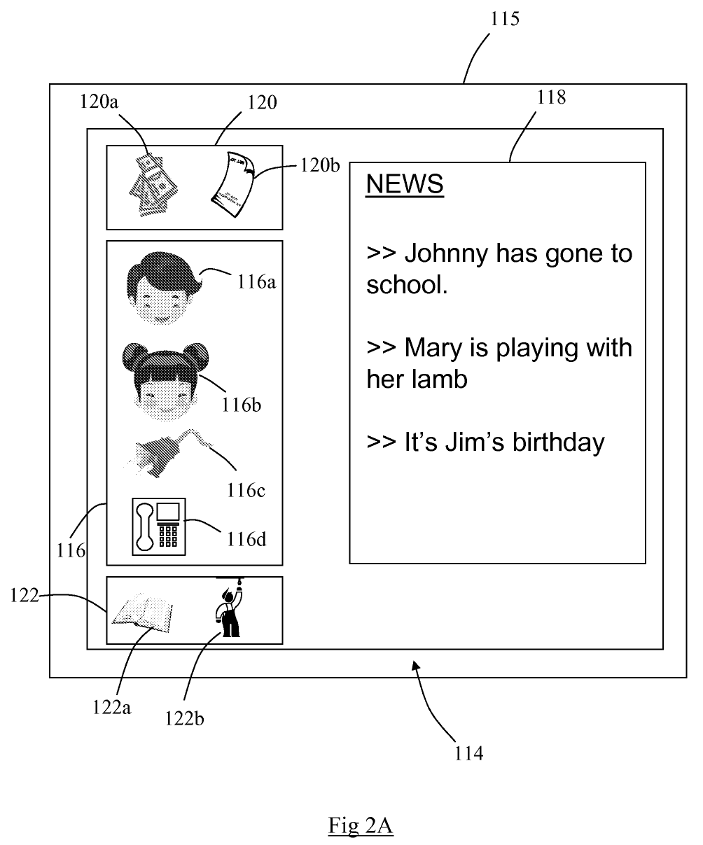

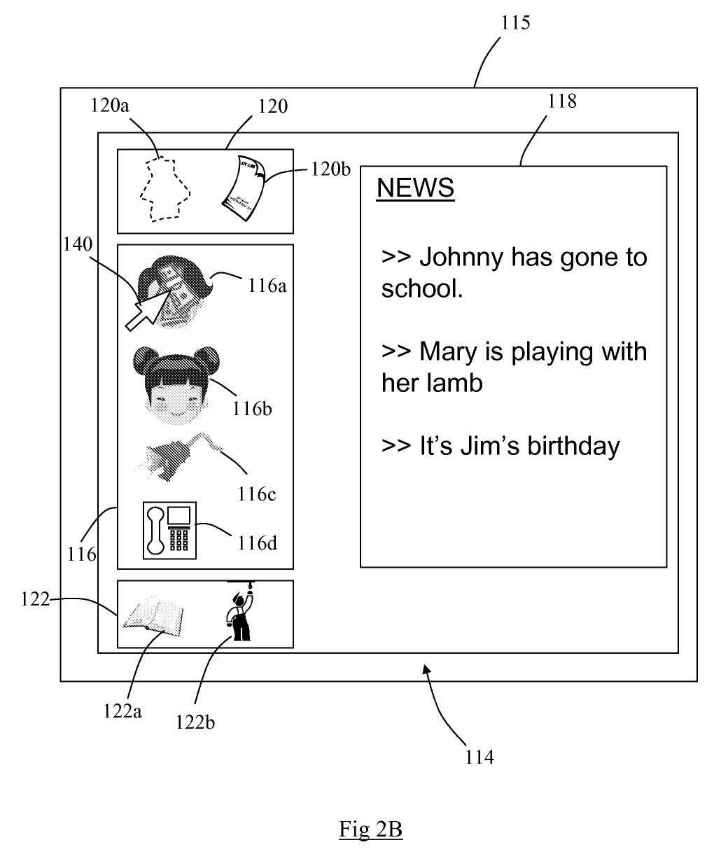

Reference will now also be made to FIGS. 2A and 2B, which are pictorial drawings of the social network GUI 114 prior to (FIG. 2A) and during (FIG. 2B) a financial transaction.

The social network GUI 114 comprises a “friends” list 116, a news feed area 118, a transaction list area 120, and a control area 122.

The friends list 116 comprises people, institutions, charities or businesses with which the user has a relationship, and which are also members of the social network. FIG. 2A illustrates four different entities in the friends list 116, but in practical embodiments many more entities than four may be listed. These four entities include two people (natural persons): Jim 116a and Mary 116b, and also two businesses (legal persons) that provide services to the user, namely: ElecCo (an electric company) 116c and PhoneCo (a telephone company) 116d.

The news feed area 118 comprises text and graphic content posted to the social network by the social network members with whom the user has a relationship (that is, those entities (legal and natural) on the friends list). The two people 116a,b primarily interact with the user via the social network by providing personal and social information about themselves and others; whereas the two businesses 116c,d primarily interact with the user via the social network to provide information about the services they provide (such as when a bill is ready for payment, new services that are available, and the like).

The friends list 116 and the news feed area 118 are populated with information delivered by the social network application 112 executing on the remote web server 102.

The transaction list area 120 provides a mechanism for allowing the user to execute financial transactions without leaving the social network. FIG. 2A illustrates two transaction options in the transaction list area 120 (although additional transaction options are possible). The first transaction option is a funds transfer option 120a. The second transaction option is a bill payment option 120b. To implement these options (that is, to transfer funds from one account to another or to pay a bill), the web-browser application 108 connects to a transaction application 124 resident on an authorization server 130.

The control area 122 includes two options, each illustrated by an icon: an account registration icon 122a; and an account editing (or updating) icon 122b.

The user selects the account registration icon 122a to register one or more of his/her financial accounts with the transaction application 124. This involves providing account details (such as account number, bank identification number, bank name, and such like). The web-browser application 108 transmits these account details (in encrypted form) together with the user's social network identifier (which may be an email address) to the transaction application 124.

The transaction application 124 stores these details in an account store 132 accessible by the transaction application 124. It should be appreciated that the user may store multiple accounts (such as a checking account, a savings account, and the like), with one of these accounts being listed as the default account. In addition to traditional bank accounts, the user may list other accounts, such as peer-to-peer accounts (for example, a Paypal (trademark) account) to enable the user to transfer funds from, or to receive credits to, this peer-to-peer account.

The account editing icon 122b is provided so that a user can update his/her accounts in the account store 132, for example, by changing the default account from checking to savings, by adding or deleting an account, or the like.

Once the user has registered at least one account, the user is able to make payments from that account and to receive funds from another member that are credited to that account, all within the social network infrastructure.

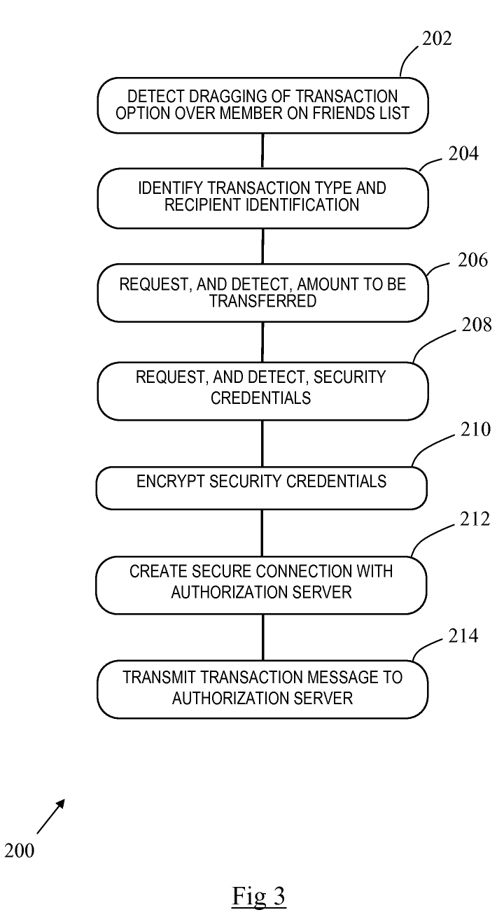

An example of a transaction will now be described with reference to FIG. 3, which is a simplified flowchart 200 illustrating steps implemented at the computer 101 in transferring funds between members of a social network using the social network GUI 114 of FIGS. 2A and 2B.

Initially, the user interacts with the social network GUI 114 by dragging one of the transaction options, for example the funds transfer option 120a, over one of the members on the friends list 116, such as Jim 116a using a computer mouse (not shown) or touch-sensitive panel (if fitted), as illustrated in FIG. 2A by pointer 140. This is detected by the transaction request component 111 (step 202).

The transaction request component 111 then identifies the type of transaction (the funds transfer option in this example) and the recipient (based on the recipient's email address, which is included in the social network GUI 114) (step 204).

The transaction request component 111 then prompts the user (via the GUI 114) to enter the amount of money to be transferred, and detects the amount entered by the user (step 206).

This is implemented by the social network GUI 114 presenting an amount field to the user for the user to complete (for example, by selecting from numbers in a drop down menu, by entering text, or the like).

The social network GUI 114 may present additional fields, such as an account field to indicate the source of funds (if more than one account is registered with the user), and a date field to indicate the date of transfer (if not immediate).

It should be appreciate that there are numerous ways for the GUI 114 to request information from the user. For example the user may be prompted to enter the amount of money to be transferred in a dialogue box. Alternatively, or additionally, there may one or more icons present that are indicative of an amount or amounts of money to be transferred. For example, if money were transferrable in increments of $10, an icon labelled with “$10” may be presented to the user and the total to be transferred incremented by repeatedly clicking this icon. Alternatively, or additionally, icons labelled with amounts of money such as “$10”, “$20”, “$30” etc., can be presented to the user who then chooses the amount that they wish to transfer by clicking the appropriate icon.

In the case of the “friend” being a legal person (for example, a company such as the electric company 116c or the telephone company 116d)) rather than a natural person (such as Jim 116a or Mary 116b) the procedure is the same. The user drags the transaction option (such as the bill payment option 120b) over the member to be paid (for example, the electric company icon 116c). The transaction application 124 then presents fields to be completed by the user. These fields include an amount field, an account source field (indicating which account of the user is to be debited), a payment date field (for when the payment is to be transferred) and optionally a customer reference field to indicate the customer who is making the payment. However, this may be linked to the user's social network identification so it may be automatically provided to the payee by the transaction application 124. Optionally, the registration process for the legal person (such as the electric company) may allow the legal person to select additional fields for presenting to any member when he/she makes a payment to that legal person via the social network.

Once the recipient of the transfer and the amount to be transferred are identified, the transaction request component 111 requests (via the GUI 114) the user to enter security credentials, typically in the form of a passcode and/or PIN (step 208).

The transaction request component 111 then encrypts the security credentials (step 210).

The transaction request component 111 then creates a secure connection with the transaction application 124 executing on the authorization server 130 (step 212). This is implemented using a web service over the Internet 104 and conventional Internet security protocols.

The transaction request component 111 then transmits a transaction message comprising: the transaction type and amount, the encrypted security credentials, the identification of the user, and the identification of the intended recipient (step 214).

At this stage, the transaction message does not include any bank account information because neither the plug-in component 110 nor the social network application 112 stores this information.

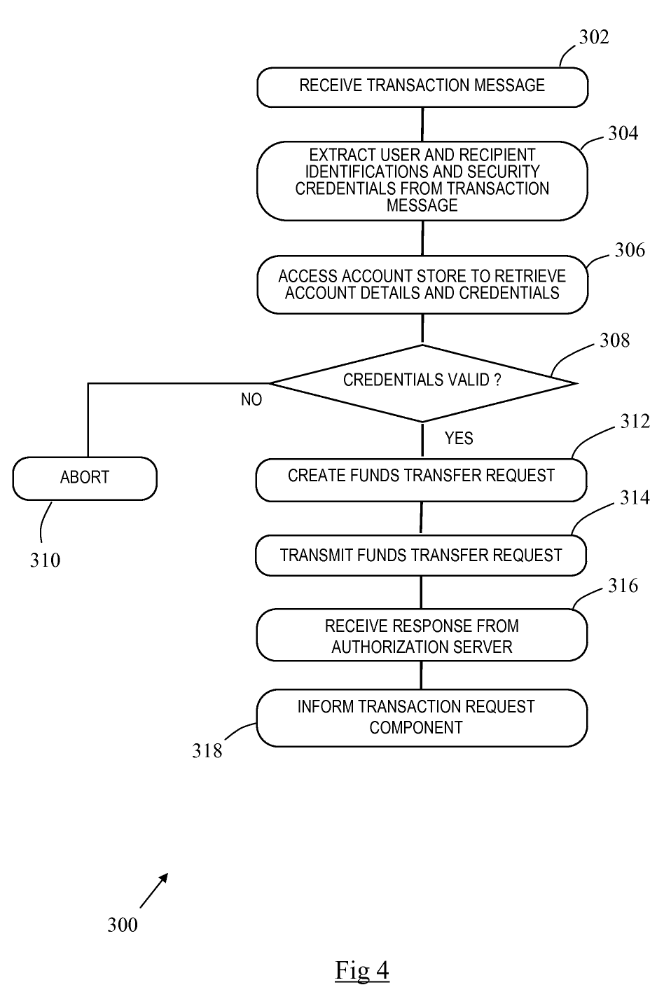

The transaction server 130 then performs the next steps, as illustrated in FIG. 4, which is a simplified flowchart 300 illustrating steps implemented by the transaction application 124 in response to the transaction message transmitted from the computer 101. The primary function of the transaction server 130 is to transform the received transaction message (which does not include any bank account information) into a funds transfer message that can be executed by a conventional electronic banking system.

The transaction application 124 receives the transaction message (step 302), extracts the user's identification and the recipient's identification (step 304), and then accesses the account store 132 to retrieve the actual account details of the user and the recipient and also the security credentials of the user (step 306).

The transaction application 124 then compares the security credentials provided by the user in the transaction message, with the security details stored in the account store 132 (step 308), after performing any necessary decryption.

If the security credentials provided do not match those stored, then the transaction is aborted (step 310) and the transaction application 124 informs the transaction request component 111 that the requested transaction will not be completed.

If the credentials match those stored on the account store 132, then the transaction application 124 creates a funds transfer request, including the retrieved account details for both the user and the recipient (including an identification of the financial institution(s) that hold the accounts for the user and for the recipient) and the amount to be transferred (step 312).

The transaction application 124 then opens a secure connection with the user's bank (or other financial provider) and transmits the funds transfer request thereto (step 314). This is implemented by the transaction application 124 connecting to a switch (transaction router) 144 (FIG. 1) via the Internet 104. The funds transfer request includes an identifier for the user's bank, which the switch 144 uses to route the transaction to the bank's back office (authorization) server 148 (FIG. 1). The back office server 148 checks that the user's account has sufficient funds to transfer to the recipient and provided the user has sufficient funds implements the transfer using known bank-to-bank transfer methods.

As is known in the art, the switch 144 is used to route a transaction to the payor bank; that is, the bank that maintains the account for the user and out of which the funds will be transferred.

Once the authorization server 148 has implemented the funds transfer request (assuming there is sufficient funds in the user's account, the accounts are valid, and the like), it responds to the transaction application 124, which receives this response (step 316).

The transaction application 124 then provides the transaction request component 111 with confirmation of the transaction (step 318). The system 100 may also automatically notify the user and the member of the social network who has received the funds transfer.

In the above example, the recipient had previously registered an account with the account store 132. However, if the user attempts to make a funds transfer to a member who has not registered an account, then the transaction application 124 may send a message to that member (for example, using the member's identification transmitted as part of the transaction message in step 214). The transaction application 124 may generate a message using the social network's messaging protocol to inform the recipient that the user is trying to transfer money to them and requesting details of an account that they wish to be credited. Alternatively, or additionally, the transaction application 124 generates an e-mail which is forwarded to an e-mail account of the recipient which is linked to their social network account.

If the recipient elects to receive funds in the form of a peer-to-peer payment, the transaction application 124 instigates the transfer of funds from the user's bank account to the recipient's preferred account, for example the recipient may wish the monies transferred to their PayPal account. In the case of payment to a peer-to-peer (P2P) transfer such as to a PayPal account, the transfer is effected in the known manner via the Internet 104.

Another feature of certain preferred embodiments is the ability to credit the user's account via imaging of a cheque. The imaging of the cheque and the extraction of the monies to be credited, payor's bank account details, and the like, will be carried out as previously described herein with reference to the payment of bills, that is, OCR or two-dimensional barcode reading routines. Crediting of the user's bank account is carried out via the switch 144 and authorization server 148.

In at least one embodiment, a fee will be charged each time a transaction is executed via the transaction application 124, typically this fee will be charged by the provider of the transaction application 124.

Alternatively, if the user received a bill by mail then the user may use a camera 150 (FIG. 1) of the user's networked computer 101 (or a digital camera or a cellphone incorporating a camera) to capture an image of the bill (or part of the bill, such as a barcode including the payee's account details) and extract the account information from the captured image using an optical character recognition (OCR) routine. The extracted information is then uploaded into the transaction application 124. In another possible embodiment, the camera 150 can capture an image of a two-dimensional barcode printed on the bill which can contain details of, for example, the amount to be paid, the account number, and the like. A utility such as RedLaser (trademark) then extracts the information from the two-dimensional barcode and the extracted information can be uploaded to the transaction application 124.

It will be appreciated that the camera 150 does not need to be integral with the computer 101 but may form part of a mobile device such as a mobile telephone which communicates with the computer 101 and the information from the captured images referred to hereinbefore are uploaded to the transaction application 124 from the mobile device via the computer 101.

It should now be appreciated that the above embodiment has the advantage that the social network GUI 114 allows a user to transfer funds to another member of the social network, to pay a bill to an organization that is a member of the social network, and the like, without leaving the social network infrastructure.

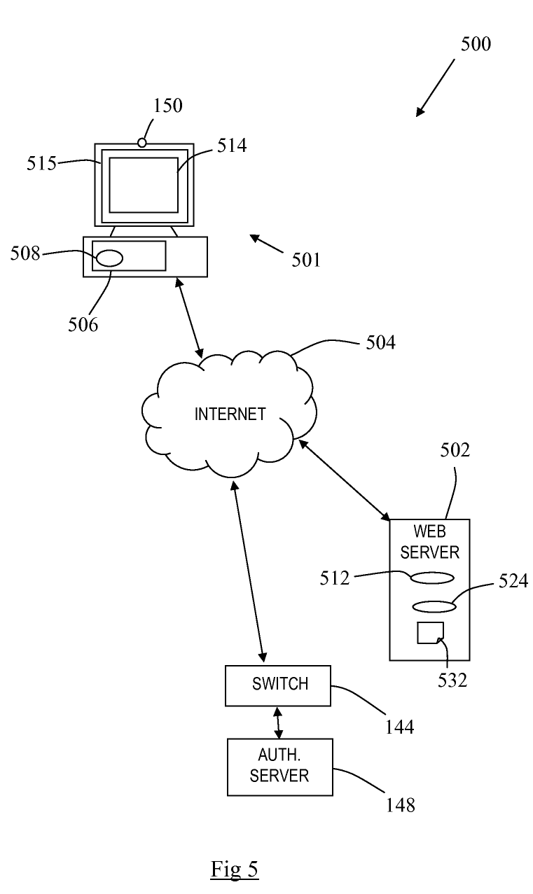

A second embodiment of the present invention will now be described with reference to FIG. 5, which is a schematic diagram of an alternative social network transaction system 500 for implementing a social network financial portal according to a second embodiment of the present invention.

The transaction system 500 comprises a networked computer 501 connected to a remote server 502 (in the form of a web server) via the network 504 (in the form of the Internet). A processor 506 in the computer 501 runs a web-browser application 508.

The web-browser application 508 can be used to access a social network application 512 executing on the web server 502. The web-browser application 508 causes a graphical user interface (GUI) 514 for the social network application 512 to be rendered on a display 515 of the computer 501.

The social network application 512 includes a financial portal application component 510 so that GUI 514 is essentially the same as GUI 114, however GUI 514 is controlled by the web server 502.

The web server also includes a transaction application 524 and an account store 532. Thus, the functions of the transaction server 130 and the web server 102 of FIG. 1 have been combined in the web server 502.

The transaction system 500 also includes the switch 144 and authorization server 148, which are identical to those described in relation to the first embodiment as shown in FIG. 1.

The operation of the transaction system 500 is very similar to that of the transaction system 100. The main difference is that the functions of the transaction server 130 and the web server 102 of FIG. 1 have been consolidated into a web server 502 in FIG. 5.

It will also be appreciated that the steps of the methods described herein may be carried out in any suitable order, or simultaneously where appropriate. The methods described herein may be performed by software in machine readable form on a tangible storage medium or as a propagating signal.

Various modifications may be made to the above described embodiments within the scope of the present invention. For example, in the above embodiment the funds transfer option 120a comprised an indicia of monetary value in the form of a bunch of banknotes; in other embodiments a different icon may be used, for example a currency symbol appropriate to the user's geographic location.

In the above embodiment, the networked computers 101,501 are depicted as a desktop computer, but in other embodiments, the networked computer 101 may be a laptop, a tablet pc, a smartphone, or the like.

1. A financial portal application operable to interact with a computer-based social network application, the financial portal application comprising:
a graphical user interface component operable to display:
a list of members of the social network associated with a user; and
at least one financial transaction option selectable by the user for transferring funds to a member of the social network, without the user having to leave the social network to execute the transaction;
and
a transaction request component for transmitting a transaction request to a transaction application that stores account information relating to the list of members.

2. A financial portal application according to claim 1, wherein the transaction request component is operable to prompt the user to enter security credentials prior to transmitting the transaction request.

3. A financial portal application according to claim 2, wherein the transaction request transmits a transaction message comprising: details of the requested transaction, the user's security credentials, and an identification of the recipient based on the social network identifier associated with that member who is to receive the money.

4. A financial portal application according to claim 3, wherein the transaction request is transmitted over a secure link and the user's security credentials include an additional level of encryption compared with the identification of the recipient based on the social network identifier.

5. A financial portal application according to claim 1, wherein the financial portal application further comprises an image processing component operable to receive an image from a document and to decode that image to ascertain account information to which payment should be sent.

6. A financial portal application according to claim 1, wherein the financial portal application is separate from the social network application executing on a web server but connected thereto via an application programming interface.

7. A financial portal application according to claim 1, wherein the financial portal application is integrated into the social network application executing on a web server.

8. A social network transaction system comprising:
a graphical user interface component operable to display to a user:
a list of members of the social network associated with the user;
and
at least one financial transaction option selectable by the user for transferring funds to a member of the social network, without the user having to leave the social network to execute the transaction;
a transaction request component for transmitting a transaction request to a transaction application;
a transaction application operable to store account information relating to the list of members and to create a funds transfer message using the transaction request; and
an authorization server operable to execute a financial transaction in response to the funds transfer message.

9. A social network transaction system according to claim 8, wherein the social network transaction system further comprises a social network application for providing social network information to the user via the graphical user interface component.

10. A social network transaction system according to claim 8, wherein the transaction application is operable to send a message to an intended recipient of the financial transaction if the intended recipient has not registered an account with the authorization server.

11. A social network transaction system according to claim 8, wherein the transaction application is operable to send a transaction confirmation message to both the user and a recipient of the financial transaction on successful completion of the transaction.

12. A social network transaction system according to claim 8, wherein the transaction application is operable to validate security credentials provided by the user prior to creating the funds transfer message.

13. A method of executing a financial transaction within a social network, the method comprising the steps of:
presenting to a user icons representing a plurality of members of the social network associated with the user;
presenting to the user at least one financial transaction option selectable by the user for transferring funds to one of the members of the social network;
receiving a request from the user to transfer funds from the user to an identified member selected from the plurality of members;
receiving information from the user identifying an amount of money to be transferred to the identified member; and
transmitting a transaction request to a transaction application so that the user can transfer funds to the identified member without the user having to leave the social network to execute the transaction.

14. A method according to claim 13, wherein the method comprises the further step of receiving security credentials from the user prior to transmitting a transaction request.

15. A method according to claim 14, wherein the method comprises the further step of encrypting the received security credentials prior to transmitting a transaction request.
